(19) United States
(12) Patent Application Publication
(10) Pub. No.: US 2010/0135264 A1
(43) Pub. Date: Jun. 3, 2010

(54) Communication Method under IEEE 802.11e Enhanced Distributed Channel Access

(75) Inventor: Thomas Nilsson, Malmo (SE)

Correspondence Address: Thomas Nilsson, Sodra Forstadsgatan 95D, Malmo, S-21420, SE

(73) Assignee: Thomas Nilsson, MALMO (SE)

(21) Appl. No.: 12/326,460

(22) Filed: Dec. 2, 2008

(51) Int. Cl. H04W 4/00

(52) U.S. Cl. 370/338

(57) ABSTRACT

The present invention provides a method for the Medium Access Control (MAC) layer in IEEE 802.11e Enhanced Distributed Channel Access (EDCA) to improve its performance. Contention parameters are used in EDCA to provide Quality of Service (QoS). However, these parameters are only good for low number of senders and there is a need to adjust the parameters dynamically when the network conditions changes. The present invention enhances the throughput for each priority class and makes it stable and almost independent to the total number of senders in the network. Hence, the need of adapting the contention parameters is not longer required. The present invention also provides capacity for a priority class that is directly proportional to the contention parameters used.

### FIELD OF THE INVENTION

The present invention relates to a Medium Access Control (MAC) method for accessing a wireless channel in a Wireless Local Area Network (WLAN), and more particular to a method of improving the throughput for each access category under the IEEE 802.11e Enhanced Distributed Channel Access (EDCA).

### BACKGROUND OF THE INVENTION

The success and widespread use of the IEEE 802.11 WLAN technology has changed the way users are connected. Many of the applications and services, like IP telephony and video conferencing, that are used in these networks would benefit from a MAC layer with support for Quality of Service (QoS). However, the IEEE 802.11 Distributed Coordination Function (DCF) (B. O'Hara, Ed., IEEE Standard for Information technology Telecommunications and information exchange between systems Local and metropolitan area networks Specific requirements Part 11: Wireless LAN Medium Access Control (MAC) and Physical Layer (PHY) Specifications. New York, N.Y., USA: IEEE, 1999.) has no support for QoS and therefore Task Group E has standardized the IEEE 802.11e amendment (T. Cole, Ed., IEEE Standard for Information technology Telecommunications and information exchange between systems Local and metropolitan area networks Specific requirements Part 11: Wireless LAN Medium Access Control (MAC) and Physical Layer (PHY) Specifications, Amendment 8: Medium Access Control (MAC) Quality of Service Enhancements. New York, N.Y., USA: IEEE, 2005).

IEEE 802.11e includes support for QoS through service differentiation. IEEE 802.11e defines two access methods, one controlled channel access, called Hybrid Coordination Function Controlled Channel Access (HCCA) and one contention based channel access called Enhanced Distributed Channel Access (EDCA). In HCCA, the access point takes the role of a centralized coordinator and schedules the resources in the network according to QoS requirements. The EDCA is on the other hand fully decentralized where each sender contends for access according to its QoS requirements. The EDCA is based on the Carrier Sense Multiple Access with Collision Avoidance (CSMA/CA) algorithm, which is used in IEEE 802.11 Distributed Coordination Function (DCF).

FIG. 1 illustrates an exemplary WLAN IEEE 802.11e network. The network consists of one or several wireless QoS Stations (QSTA) 10, associated to a QoS Access Point (QAP) 11 in a QoS Basic Service Set (QBSS) 12. The QAP is then connected to a distribution system 13 than connects the QBSS to other networks. More than one QBSSs form an extended service set 14.

IEEE 802.11e specifies eight priorities, referred to as user priorities (UP) and a packet with a specific UP belongs to an access category (AC). In Table 1 the priority mapping between UPs and ACs is shown. Each QSTAs maintains four ACs.

TABLE 1
IEEE 802.11e mapping between user priorities and access categories.

| | | Access Category | |
|---|---|---|---|
| Priority | User Priority (UP) | (AC) | Designation |
| lowest | 1 | AC_BK | Background |
| | 2 | AC_BK | Background |
| . | 0 | AC_BE | Best Effort |
| . | 3 | AC_BE | Best Effort |
| . | 4 | AC_VI | Video |
| | 5 | AC_VI | Video |
| | 6 | AC_VO | Voice |
| highest | 7 | AC_VO | Voice |

FIG. 2 illustrates the priority mapping 21 and the local queues 22 that are implemented by each AC. The four ACs are equipped with specific sets of contention parameters 23 and each AC contends independently for access to the channel. Internal collisions may occur but are solved by allowing the queue with the highest priority to gain access to the channel 24. The EDCA standard specifies default values of the contention parameters but the QAP has the flexibility to adjust the parameters dynamically by announcing them in selected beacons. The beacons contain QBSS specific information and are broadcasted by the QAP periodically to all QSTAs in the QBSS. QSTAs operating under EDCA contend for a so-called transmission opportunity (TXOP). This is an interval of time when a particular QSTA is allowed to access the channel. Depending on the length of TXOP, QSTAs may transmit more than one packet. The following contention parameters are used to differentiate between ACs:
The maximum duration of time, TXOP[AC], a specific AC is allowed to gain access to the channel.
The minimum contention window, CWₘᵢₙ[AC], a specific AC uses to control access to the channel.
The maximum contention window, CWₘₐₓ[AC], a specific AC uses to control access to the channel.
Arbitration interframe space number, AIFSN[AC], is the number of time slots a specific AC uses to determine the arbitration interframe space (AIFS).

Following a successful transmission and when the channel becomes idle each AC, which has pending packets to send, must sense the channel idle for an AIFS interval. This interval is different for each AC. If the channel is idle during the whole AIFS interval, each AC will start to decrement its backoff counter, one for each time slot, as long as the channel remains idle. An AC will transmit its pending packet when its backoff counter equals zero. All other ACs will then freeze their backoff counters.

The backoff counter for each AC is chosen uniformly from the interval (0,1, . . . ,CW[AC]). And the AIFS[AC] period of time is defined as follows

AIFS[ACI]=AIFSN[AC]*aSlotTime+aSIFSTime, (1)

where aSlotTime is the slot time, aSIFSTime is the normal Short Inter frame Space (SIFS) duration. The contention window for each AC is updated as follows

CW[AC]=min(CWₘₐₓ[AC],(CW[AC]+1)*2−1), (2)

after each unsuccessful transmission attempt (signalled by the automatic repeat request mechanism). This approach to adjust the CW is referred to as the binary exponential backoff algorithm. The CWₘₐₓ[AC] is the maximum allowed value of the CW[AC]. The CW[AC] is re-set to the CWₘᵢₙ[AC] following successful transmissions. A collision happens if two or more ACs starts to transmit at the same time. If the colliding ACs are within the same QSTA, the AC with the highest priority will transmit while lower priority ACs will double their CWs. This is called an internal collision. External collisions happen between ACs from different QSTAs. In this case all the colliding ACs will double their CWs.

The default values of the contention parameters are listed in Table 2 according to (Wireless LAN Medium Access Control (MAC) and Physical Layer (PHY) Specifications, Amendment 8: Medium Access Control (MAC) Quality of Service Enhancements. New York, N.Y., USA: IEEE, 2005).

TABLE 2
Default values of the contention parameters.

| AC | AIFSN | CWₘᵢₙ | CWₘₐₓ |
|---|---|---|---|
| AC_VO | 2 | 7 | 15 |
| AC_VI | 2 | 15 | 31 |
| AC_BE | 3 | 31 | 1023 |
| AC_BK | 7 | 31 | 1023 |

FIG. 3 illustrates an example of four ACs, within one QSTA, contending for access to the channel. The lower priority ACs (AC_BE and AC_BK) must sense the channel idle for longer AIFS times before starting to decrement their backoff counters (BO), and therefore it takes a longer time for the backoff counters to reach zero. In contention phase 1, AC_VO wins the contention since its backoff counter reaches zero first. All other ACs freeze their backoff counters. In the contention phase 2, the AC_VO selects a new backoff value and starts to count down following the AIFS interval. Other ACs resume the countdown of their backoff counters after sensing the channel idle for their specific AIFS times. The third contention results in a collision 31 between AC_VO and AC_VI. Since this is an internal collision access is granted to the higher priority AC (AC_VO) while the lower priority (AC_VI) will double its CW.

High priority ACs have lower values of the contention parameters, i.e. CWₘᵢₙ[AC], CWₘₐₓ[AC] and AIFSN, and can therefore access the channel more frequently. However, when then number of high priority ACs increases in the network, throughput starts to degrade since collisions among these ACs increase rapidly. This leads to poor utilization of the channel and starvation of low priority ACs. The reason is that the default contention parameters are only optimal for very few high priority ACs.

Earlier studies have shown that the default values of the contention parameters are only good for scenarios with few high priority ACs and under moderate traffic loads, e.g. see (S. Kuppa and R. Prakash, “Service differentiation mechanisms for IEEE 802.11 based wireless networks,” in IEEE Wireless Communications and Networking Conference, vol. 2, March 2004, pp. 796-801). The access point has the flexibility to adjust the contention parameters but no algorithm for this purpose is provided in the standard, see Chapter 9.1.3.1 in (Wireless LAN Medium Access Control (MAC) and Physical Layer (PHY) Specifications, Amendment 8: Medium Access Control (MAC) Quality of Service Enhancements. New York, N.Y., USA: IEEE, 2005.).

The binary exponential backoff algorithm, used in IEEE 802.11 DCF and IEEE 802.11e EDCA, adopts the CWs in a non optimal way (F. Cal`1, M. Conti, and E. Gregori, “Dynamic tuning of the IEEE 802.11 protocol to achieve a theoretical throughput limit,” IEEE/ACM Transaction on Networking, vol. 8, no. 6, pp. 785-799, 2000) and this is one of the causes behind the need of adapting the contention parameters in EDCA. A collision forces the colliding ACs to double their CWs. However, this information about congestion is not used by other ACs to adjust their CWs. Furthermore, a successful transmission forces the AC to reset its CW to the minimal value that may not be optimal in all situations. To adapt the contention parameters requires the presence of a QAP that computes and distributes the new parameter values in the QBSS. This is however, not possible in an ad-hoc scenario.

Another problem in EDCA is how to adjust the contention parameters, under varying network conditions, to achieve a certain capacity ratio between the ACs and at the same time achieve high channel utilization. Previous studies have shown that adaptation of multiple contention parameters, like CW and AIFSN, may not be desirable to achieve the two goals (Y. Ge, J. C. Hou, and S. Choi, “An analytic study of tuning systems parameters in IEEE 802.11e enhanced distributed channel access,” Comput. Networks, vol. 51, no. 8, pp. 1955-1980, 2007). There is a complex relationship between the contention parameters used by an AC and the relative share of the total capacity it achieves, especially under varying network conditions. It would be desirable to know this relationship to effectively adjust the contention parameters for each AC to achieve a certain capacity proportional to the parameter values used. This can be achieved if only CW differentiation is used (J.-D. Kim and C.-K. Kim, “Performance analysis and evaluation of IEEE 802.11e EDCF: Research articles,” Wirel. Commun. Mob. Comput., vol. 4, no. 1, pp. 55-74, 2004).

### PRIOR ART

A large number of modifications and improvements of the EDCA have been proposed, mainly with the focus of adapting the CWs to channel and network conditions that will improve the throughput performance.

T. H. Kim et al. propose in (T. H. Kim, L. Marwitz, and D. K. Kim, “Dynamic offset contention window (DOCW) algorithm for wireless MAC in 802.11e based wireless home networks,” Lecture Notes in Computer Science, 2003) a modified backoff scheme, in EDCA, called Dynamic Offset Contention Window (DOCW) algorithm, which dynamically adjusts CW values to network conditions. Their simulation results show that the algorithm enhances the throughput for low priorty ACs.

L. Romdhani et al. propose in, L. Romdhani, Q. Ni, and T. Turletti, “Adaptive EDCF: Enhanced service differentiation for IEEE 802.11 wireless ad hoc networks,” in IEEE WCNC'03 (Wireless Communications and Networking Conference, March 2003), an enhancement to the IEEE 802.11e, called Adaptive Enchanced Distirbuted Coordination Function (AEDCF). Their method tries to adapt the CWs of each AC according to application requirements and network conditions that will increase the channel utilization.

Several techniques have been proposed to improve the performance of EDCA by allowing the QSTAs to adapt their CWs according to the channel state. H. Artail et al. propose in, H. Artail, H. Safa, J. Naoum-Sawaya, B. Ghaddar, and S. Khawam, “A simple recursive scheme for adjusting the contention window size in IEEE 802.11e wireless ad hoc networks,” Comput. Commun., vol. 29, no. 18, pp. 3789-3803, 2006, a modification to EDCA that takes into account the network state before resetting the CWs after successful transmissions. In the new technique, the congestion level of the network is sensed by using previous CW values. Their simulation results show that the throughput and utilization of the channel are improved. M. Frikha et al. propose in, M. Frikha, F. B. Said, L. Maalej, and F. Tabbana, “Enhancing IEEE 802.11e standard in congested environments,” in AICT-ICIW '06: Proceedings of the Advanced Int'l Conference on Telecommunications and Int'l Conference on Internet and Web Applications and Services. Washington, D.C., USA: IEEE Computer Society, 2006, p. 78, a set of methods in order to enhance the performance of EDCA in congested environments and under high traffic loads by using a slow decrease scheme and a dynamic method to adjust the minimum CW.

Y. Tanigawa et el. propose in, Y. Tanigawa, J.-O. Kim, H. Tode, and K. Murakami, “Proportional control and deterministic protection of QoS in IEEE 802.11e wireless LAN,” in IWCMC '06: Proceeding of the 2006 international conference on Communications and mobile computing. New York, N.Y., USA: ACM Press, 2006, pp. 1147-1152, two adaptation methods to achieve stable capacity ratios under varying network conditions between high and low priority ACs. The AIFS values of the high and low priority ACs are adjusted dynamically so that the throughput ratio between the ACs is fixed to a target value.

A randomized Arbitrary Interframe Space Number (AIFSN) algorithm is presented in S. Gaur, C. Tavares, and T. Cooklev, “Improved performance of CSMA/CA WLAN using a random inter-frame spacing algorithm,” in IWCMC '06: Proceeding of the 2006 international conference on Communications and mobile computing. New York, N.Y., USA: ACM Press, 2006, pp. 407-412. High priority ACs suffer from increasing collision probability when more QSTAs enter the AC. Instead of having a fixed AIFSN, each AC selects a discrete random variable from the interval (N, N+1, . . . , M) using a probability density functions, e.g. uniform or Bernoulli distribution. The interval boundaries N[AC] and M[AC] are AC specific values. The use of a randomized AIFSN further reduces the probability of two ACs chosing the same backoff value. Hence, there is an additional level of separation between ACs and the collision probability is decreased. It is well known that AIFS have this property. Although this algorithm improves the throughput performance of the EDCA, it does not eliminate the need of adjusting the CWs under varying network conditions since the collision probability still depends on the size of the CWs and the number of QSTAs in each AC. No approach for adjusting the CWs more efficiently, than in EDCA, to the network conditions is provided. Furthermore, this algorithm cannot provide capacity for an AC that is directly proportional to the contention parameters used by the AC, i.e. CW[AC], N[AC] and M[AC]. There is no simple way of setting these parameters to control the capacity share for each AC in the network.

A multi-class model is derived by Y. Ge et al. in, Y. Ge, J. C. Hou, and S. Choi, “An analytic study of tuning systems parameters in IEEE 802.11e enhanced distributed channel access,” Comput. Networks, vol. 51, no. 8, pp. 1955-1980, 2007, to adapt the EDCA contention parameters, by the QAP, to varying network conditions using optimal parameters. The model only focuses on CW adaptation to provide proportional service differentiation, pre-specified throughput ratios among the ACs and high channel utilization.

### SUMMARY OF THE INVENTION

The present invention relates to how each AC, in a QSTA or QAP, operates when trying to access the channel in an IEEE 802.11e EDCA network. In order to remove the need of adjusting the contention parameters to the network conditions in IEEE 802.11e EDCA, the present invention makes modifications to the bakoff and AIFS procedures. The performance in aggregated throughput and channel utilization can be significantly improved and are almost independent to the total number of QSTAs and ACs in the QBSS, without any adaptation of parameters. The need of adapting the parameters, using the present invention, is not longer required. The present invention also provides capacity for an AC that is directly proportional to the contention parameters used by the AC.

When an AC has data to send, then according to the present invention each AC, independent of its priority, will select a Random AIFSN (RIFSN) number of slots uniformly from a fixed interval of length H, i.e.

RIFSN=UniRnd(1,2, . . . ,H), where H is the size of the interval.

This RIFSN value is then used to compute the AIFS according to,

AIFS=RIFSN*aSlotTime+aSIFSTime,

where aSlotTime is the slot time, aSIFSTime is the normal Short Inter Frame Space (SIFS) duration. The AC must then sense the channel idle for the AIFS time before starting to decrement its backoff counter. If the channel becomes busy before the AIFS time has expired then the AC adds a random value from a discrete uniform distribution over a fixed interval (1,2, . . . , K), where K is the size of the interval, to its current backoff timer. This is different from prior art where the focus is on adapting the CWs. ACs that have started to decrement their backoff counters when the channel becomes busy will simply freeze their counters. Each AC keeps one fixed CWₘᵢₙ[AC] that is used to compute the backoff following each of its own transmission attempts. The CWs are not doubled as a result of internal or external collisions and therefore the CWₘₐₓ[AC] is not longer required.

Instead the backoff counter has an upper limit, BOₘₐₓ, and it should not be increased above this limit. If the current backoff counter for an AC is very close to BOₘₐₓ then the interval used to increase the backoff, i.e. (1,2, . . . ,K), should be adjusted to ensure that the limit is not exceeded.

The present invention significantly improves the throughput performance and channel utilization of the EDCA for a variable number of QSTAs without the need of adjusting the parameters H and K. Furthermore, in the present invention the achieved throughput for a specific AC is directly proportional to its CWmin[AC], and this is not the case for EDCA. The present invention works in a fully decentralized manor which is different from EDCA that needs a QAP to compute and distribute the contention parameters dynamically.

### BRIEF DESCRIPTIONS OF THE DRAWINGS

FIG. 1 illustrates a block diagram of an IEEE 802.11e extended service set comprising two QoS Basic Service Sets (QBSS) with a number of QoS Stations (QSTA) associated to a QoS Access Point (QAP).

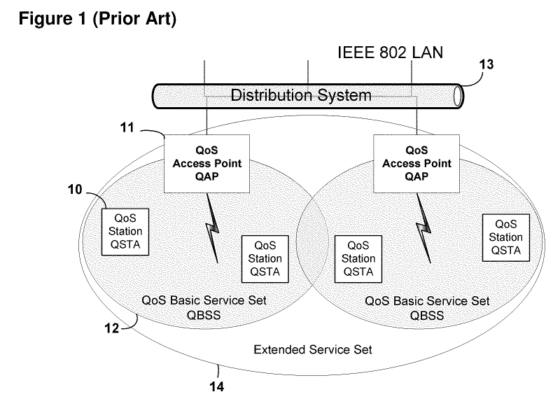

FIG. 2 illustrates a block diagram of the four ACs, inside one QSTA, with their individual contention parameters and buffer queues.

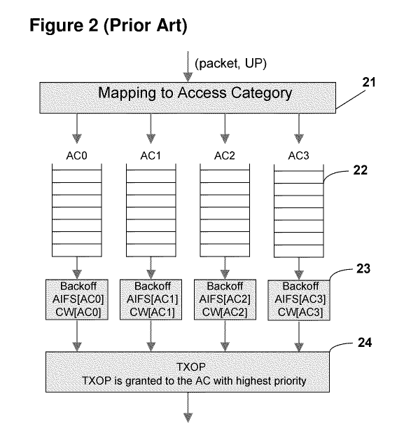

FIG. 3 illustrates an example of the internal contention between the four ACs inside one QSTA in EDCA.

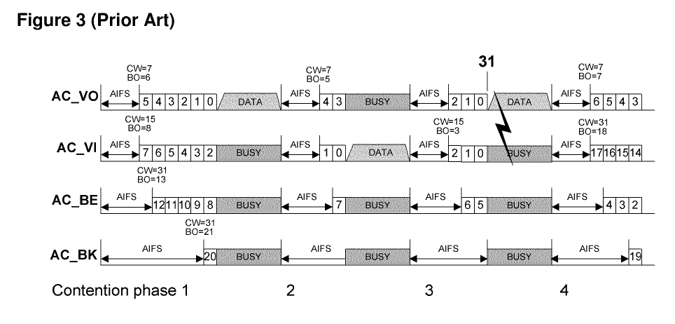

FIG. 4 illustrates a flow diagram of the present invention.

FIG. 5 illustrates an example of three QSTAs, having one AC each, contending for access according to the present invention.

FIG. 6 illustrates the aggregated throughput for i-EDCA, from a simulation study, for each AC when changing the number of QSTAs in each AC during the simulation.

FIG. 7 illustrates the aggregated throughput for EDCA, from a simulation study, for each AC when changing the number of QSTAs in each AC during the simulation.

FIG. 8 illustrates the aggregated throughput for i-EDCA for each AC, from a simulation study, when gradually increasing the number of QSTAs in each AC and the result is compared to when optimal CWs are used by each QSTA as to maximize the aggregated throughput.

FIG. 9 illustrates the aggregated throughput for EDCA for each AC, from a simulation study, when gradually increasing the number of QSTAs in each AC.

### DETAILED DESCRIPTION OF THE INVENTION

A method for medium access control in an IEEE 802.11e EDCA WLAN is described in detail herein. The present invention provides a method used by each AC to access the channel, more specifically; the present invention can be used to improve the performance of the IEEE 802.11e EDCA standard so the need of adjusting the contention parameters is not longer required. The present invention uses only one contention parameter, the CWₘᵢₙ[AC], to differentiate between ACs. However, the present invention is not limited to using only this contention parameter. The TXOP parameter can be used to further differentiate between ACs. The AIFSN is however not longer used as a contention parameter to differentiate between ACs.

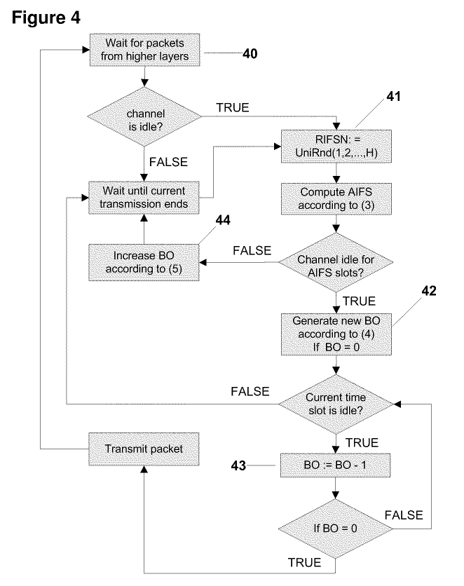

FIG. 4. illustrates a flow chart of the invention. When an AC within a QSTA that has data to send 40 selects, when the channel becomes idle, a new Random AIFSN (RIFSN) value 41 uniformly from the discrete interval (1, 2, . . . , H). The AIFS time is then computed as follows

AIFS=RIFSN*aSlotTime+aSIFSTime, (3)

where, RIFSN=UniRnd(1,2, . . . ,H), aSlotTime is the slot time and aSIFSTime is the normal SIFS duration. Here, the UniRnd should be interpreted as a function that returns a random number that is selected uniformly from the interval provided as the argument. All ACs select their RIFSN value from the same interval. Thus, RIFSN and consequently AIFS are not used to differentiate between ACs.

Each AC belonging to a QSTA selects a new backoff (BO) 42 uniformly from the discrete interval

(0, 1, . . . , CW min[AC]), i.e.

BO[AC]=UniRnd(0,1, . . . ,CWₘᵢₙ[AC]), (4)

in the cases when backoff is required by the IEEE 802.11e and the current backoff has a value of zero. Each AC maintains one fixed CWₘᵢₙ[AC] and the backoff time is always selected from this CW. Internal or external collisions have no effect on the CWₘᵢₙ[AC], i.e. an AC does not double its CW following collisions between ACs from different QSTAs or ACs within the same QSTA.

When the channel has been sensed idle for an AIFS time, the AC starts to decrement its backoff counter 43, see FIG. 4. If the channel becomes busy before the AIFS time has expired, the AC will select a random value, k, uniformly from the discrete interval (1,2, . . . ,K), and add this value to its current backoff counter 44. This is the only time when the backoff is increased. A maximum value, BOₘₐₓ, is introduced to set an upper size of the BO. The interval where the random value k is chosen is adjusted if the current backoff is close to the BOₘₐₓ. The backoff counter for an AC is increased as follows

BO[AC]=BO[AC]+UniRnd(1,2, . . . ,Limit), (5)

where Limit=min(K, BOₘₐₓ=BO[AC]).

The motivation behind increasing the backoff counter 44 in this way is that heavy congestion in the network is signalled by decreasing number of idle slots between transmissions. This leads to a higher fraction of ACs that are unable to sense the channel idle for their AIFS time. These ACs will then increase their backoff counters according to (5) and the congestion level will be reduced. This is a faster method to respond to congestion than in IEEE 802.11e EDCA, where an AC must pay the cost of a collision to adjust its CW.

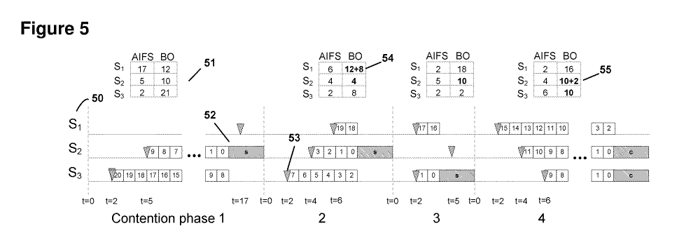

FIG. 5 shows an example with three QSTAS, S₁, S₂ and S₃ 50, having one AC each, contending for access. The tables 51 contain the values of AIFS and BO for each QSTA (S₁ to S₃) and each contention phase (1 to 4). The t variable represents the time in slots and starts directly from 0 following a transmission. The upside down triangle represents the AIFS time for each AC in each contention phase. Backoff counters that are increased or uniformly selected from the CW in each contention phase are represented by bolded values in the BO column in the tables.

In contention phase 1, all the ACs have packets to send and select 17, 5 and 2 as AIFS times. It is assumed that all the ACs have remaining backoff time from previous transmission attempts. The AC belonging to S₃ waits 2 (t=2) and starts to decrement its backoff counter and at t=5, the AC in S₂ starts its countdown. At t=15 52, the backoff counter of the AC belonging to S₂ reaches 0 and it starts the transmission and the other ACs freeze their backoff counters. The AC in S₁ has not yet started its countdown when the channel becomes busy and therefore adds a random value to its backoff counter.

The AC in S₃ continues to decrement its backoff after an AIFS time of 2 (t=2) in the contention phase 2 53. The other two ACs also start to decrement their counters after their specific AIFS times. However, the AC belonging to S₁ has added 7 slots to its backoff counter 54 because the channel became busy before its AIFS time expired in contention phase 1. In contention phase 3, the AC in S₂ does not start to decrement its backoff and will consequently add a random value to its backoff in contention phase 4 55.

### Empirical Study

To test the performance of the present invention compared to the EDCA, a simulation study is presented. From this point forward the present invention is referred to as the improved EDCA (i-EDCA). The two protocols are implemented in the GloMoSim environment (X. Zeng, R. Bagrodia, and M. Gerla, “GloMoSim: A library for the parallel simulation of large scale wireless networks,” in the 12^{th} Workshop on Parallel and Distributed Simulation, 1998). The two-ray model is used to model the pathloss, and no fading is assumed. For the physical layer the IEEE 802.11a standard is assumed, with a fixed modulation rate of 6 Mbps. The simulation area is of size 300×300 meters with a QAP located in the centre. The QSTAs are uniformly distributed and there is no mobility. Full connectivity in the network is assumed, i.e. no hidden terminals. It is assumed that every AC in the QBSS always has a new packet in queue ready for transmission, i.e. the network operates in saturated conditions. The default values of the parameters in EDCA are used. Table 3 shows the parameters used for i-EDCA. In this study AC_VO is referred to as 0 and AC_VI is referred to as 1 and so on.

TABLE 3
Default values of the parameters used in i-EDCA.

| Parameter | Value |
|---|---|
| CWₘᵢₙ[AC0] | CWₘᵢₙ * 1 |
| CWₘᵢₙ[AC1] | CWₘᵢₙ * 2 |
| CWₘᵢₙ[AC2] | CWₘᵢₙ * 4 |
| CWₘᵢₙ[AC3] | CWₘᵢₙ * 8 |
| CWₘᵢₙ | 31 |
| BOₘₐₓ | 1023 |
| H | 10 |
| K | 15 |

A scenario with increasing and decreasing number of QSTAs during the simulation is considered. It is assumed that each QSTA has one AC and the network starts with one QSTA in each AC (One QSTA has AC0 and on has AC1 and so on) and the number is doubled every 20s until the network has a total of 64 QSTAs (16 in each AC). The network is then left unchanged for 70s and then the number in each class is divided in half every 20s until only one QSTA remains in each AC. The simulation is run for 300 seconds.

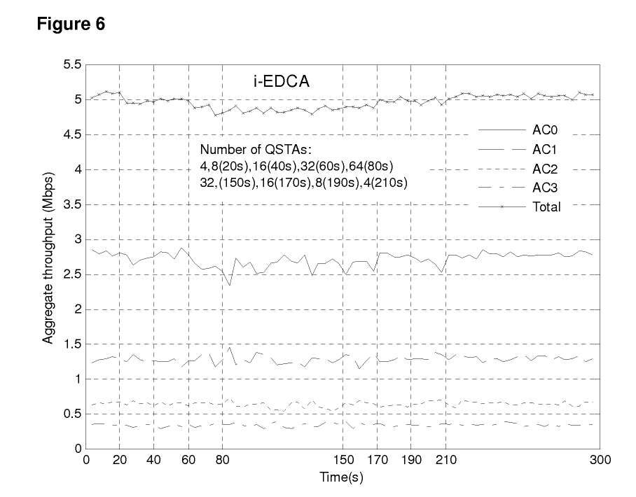

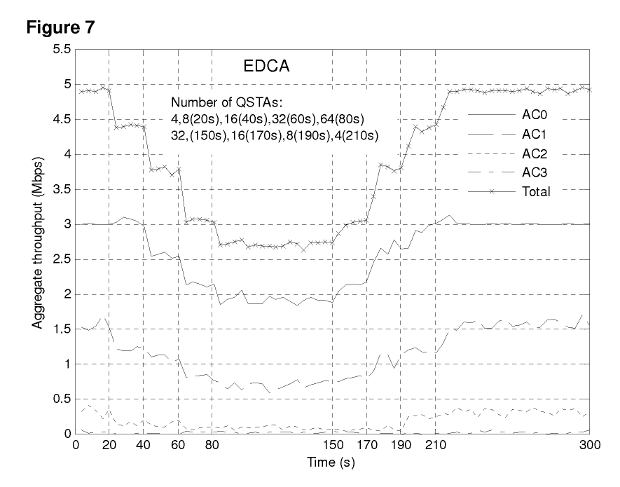

FIG. 6 shows the simulation results for i-EDCA. Each line represents the aggregated throughput for all ACs having the same priority. There is a small decrease in aggregated throughput when doubling the number of QSTAs. The throughput ratios between the ACs remain the same during the simulation. FIG. 7 shows the same scenario for EDCA when the default contention parameters are used. The aggregated throughput for each AC quickly drops when the number of QSTAs in each AC increases.

In the next simulation scenario, we have compared the results for i-EDCA with a fixed CW scheme for increasing the number of QSTAs in each AC. In the fixed CW scheme the CWs are kept constant for each AC. Here, the optimal CW sizes that maximizes the aggregated throughput according to (41) in the analytical model proposed by, Y. Ge, J. C. Hou, and S. Choi, “An analytic study of tuning systems parameters in IEEE 802.11e enhanced distributed channel access,” Comput. Networks, vol. 51, no. 8, pp. 1955-1980, 2007, is used. This model is based on p—persistent CSMA and can be used to compute the CWs that yield specific capacity ratios between the ACs and that maximize the channel utilization. The p—persistent version of CSMA has been shown to closely approximate IEEE 802.11 DCF (F. Cal`1, M. Conti, and E. Gregori, “Dynamic tuning of the IEEE 802.11 protocol to achieve a theoretical throughput limit,” IEEE/ACM Transaction on Networking, vol. 8, no. 6, pp. 785-799, 2000). The throughput results using the optimal CWs represent an upper bound for CSMA/CA protocols.

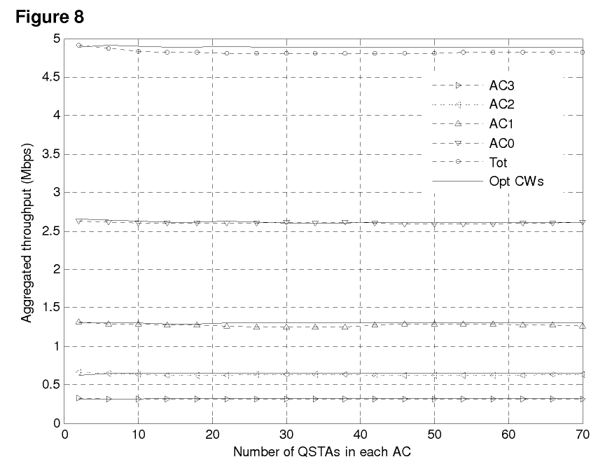

In FIG. 8 the aggregated throughput for all ACs having the same priority is shown for an increasing number of QSTAs. The performance of i-EDCA is compared to a fixed CW scheme using optimal CWs for each AC. Here the CWs are computed so that the ACO has twice the capacity of AC1 and AC1 has twice the capacity of AC2 and so on. The results for i-EDCA are extremely close to that of the optimal (there are eight curves in FIG. 8). It is clear that the throughput ratios are stable when increasing the number of QSTAs in each AC. The aggregated throughput is very high and appears to be almost independent of the number of QSTAs. Clearly there is little need to adjust the parameters in i-EDCA. Using optimal CWs require the presence of a QAP that manages the computation and distribution of the CWs, whereas i-EDCA is fully decentralized and still yields almost the same performance. It can also be seen in FIG. 8 that the aggregated throughput (capacity) for an AC in i-EDCA is directly proportional to its CWₘᵢₙ[AC]. For example, AC0 has twice the throughput compared to AC1 since CWₘᵢₙ[AC0]=2*CWₘᵢₙ[AC1].

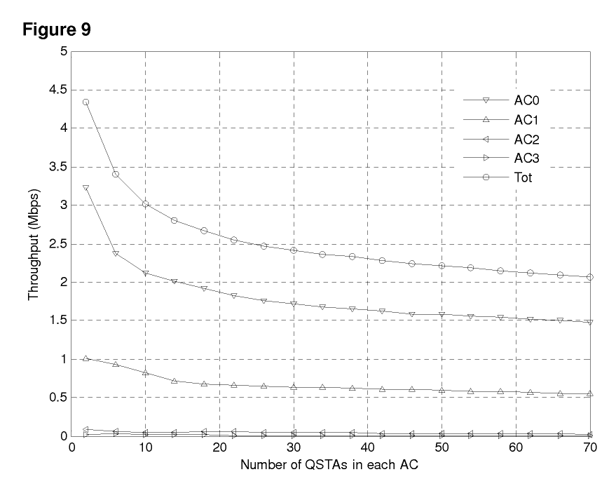

The same scenario with an increasing number of QSTAs in each AC, for EDCA, is shown in FIG. 9. The aggregated throughput for all ACs having the same priority is rapidly decreasing when increasing the number of QSTAs. AC2 and AC3 experience starvation very quickly and the throughput ratios between the ACs do not remain constant. There is no starvation for the low priority ACs in i-EDCA, see FIG. 8.

What is claimed is:

1. A method of providing improved throughput for each access category in an IEEE 802.11e Wireless LAN under varying network conditions that removes the need of adjusting the contention parameters dynamically, said method comprising the steps of:
When an access category has a packet to send and determines the channel to be idle, computing an arbitration interframe space period of time and determining if the channel remains idle for this period of time; and
in response to determining the channel not to be idle for the computed arbitration interframe space period of time, increasing the backoff time associated with the access category, and deferring access until the channel becomes idle again; and
in response to determining the channel to be idle for the computed arbitration interframe space period of time, selecting a random backoff time uniformly from the contention window associated with the access category, provided that no backoff time from previous attempts exists; and
transmitting the data packet for the access category when the channel has been determined to be idle for a number of slots equal to the backoff time.

2. The method of claim 1, further comprising:
after an internal or external collision is detected by an access category, said access category refrains from doubling its contention window.

3. The method of claim 1, wherein the arbitration interframe space is computed by adding the short interframe space and a random number of slots selected uniformly from one predetermined interval

4. The method of claim 1, wherein the backoff time is increased with a random number of slots selected uniformly from one predetermined interval.

5. The method of claim 4, wherein the backoff time is not increased above a predetermined value.

6. The method of claim 5, wherein the predetermined interval is adjusted, if necessary, so that the backoff time is not increased above the predetermined value.
